(19) United States
(12) Patent Application Publication
(10) Pub. No.: US 2017/0217788 A1
(43) Pub. Date: Aug. 3, 2017

(54) WATER SUPPLY MANAGEMENT SYSTEM

(71) Applicants: Mei NG, Toronto (CA); Ka Chun LI, Hong Kong (CN)

(72) Inventors: Mei NG, Toronto (CA); Ka Chun LI, Hong Kong (CN)

(21) Appl. No.: 15/328,139

(22) PCT Filed: Jul. 21, 2014
(86) PCT No.: PCT/CN2014/082629

§ 371 Date: Jan. 23, 2017

(51) Int. Cl. C02F 1/00; C02F 1/28; C02F 1/44

(52) U.S. Cl. CPC C02F 1/008; C02F 1/001; C02F 1/444; C02F 1/283; C02F 2209/03; C02F 2209/06; C02F 2209/07; C02F 2209/10; C02F 2209/11; C02F 2209/02; C02F 2209/40; C02F 2209/008

(57) ABSTRACT

A water supply management system for managing a water supply having one or more water processing or control devices is disclosed. The system comprises: one or more sensors (201, 202, 203, 204, 205, 206), each sensor taking measurements of one or more parameters of a water supply passing through the water supply system; a communication module (103) connected to the sensors (201, 202, 203, 204, 205, 206) to receive the measurements in the form of data from the sensors (201, 202, 203, 204, 205, 206); and at least one computing device (106) remotely connected to the communication module (103) to receive the data from the communication module (103), thereby to allow a user to use the computing device (106) to remotely monitor in real-time a status of one or more of the processing or control devices based on the data. Also disclosed is a water processing or control device for use in such a system.

### TECHNICAL FIELD

The present invention relates to water supply management systems and methods of managing water supply systems.

### BACKGROUND ART

Current water supply systems typically comprise: a pre-filtration portion, an automatic shut-off valve, a reverse osmosis membrane, an inline flow control device, a post-filtration portion and a storage tank. Usually, the replacement of filter elements is determined by the time elapsed or the accumulated flow volume. Since water quality is not measured or considered, the replacement schedules of these filter elements is not optimized relative to the actual water quality or other performance factors of the water supply system. The recommended replacement schedules available are also not optimized relative to the actual water quality or other performance factors of the water supply system.

### DISCLOSURE OF INVENTION

### Solution to Problem

### Technical Solution

The present invention provides, in a first aspect, a water supply management system for managing a water supply system having one or more water processing or control devices, the water supply management system comprising:

one or more sensors, each sensor taking measurements of one or more parameters of a water supply passing through the water supply system;

a communication module connected to the sensors to receive the measurements in the form of data from the sensors; and

at least one computing device remotely connected to the communication module to receive the data from the communication module, thereby to allow a user to use the computing device to remotely monitor in real-time a status of one or more of the processing or control devices based on the data.

In a second aspect, the present invention provides a water processing or control device for a water supply system, the water processing or control device comprising a sensor, the sensor being part of a water supply management system for managing a water supply system, the sensor taking measurements of one or more parameters of a water supply passing through the water supply system, the water supply management system comprising:

a communication module connected to the sensor to receive the measurements in the form of data from the sensor; and

at least one computing device remotely connected to the communication module to receive the data from the communication module, thereby to allow a user to use the computing device to remotely monitor in real-time a status of the processing or control device based on the data.

In a third aspect, the present invention provides a water processing or control device for a water supply system, the water processing or control device comprising an identification device that provides identification information corresponding to the water processing or control device, the identification device for use in water supply management system comprising:

one or more sensors, each sensor taking measurements of one or more parameters of a water supply passing through the water supply system;

a communication module connected to the sensors to receive the measurements in the form of data from the sensors;

a reader that detects the presence or absence of the water processing or control device in the water supply system, reads the identification information from the identification device, and provides the identification information in the form of data to the communication module; and

at least one computing device remotely connected to the communication module to receive the data from the communication module, thereby to allow a user to use the computing device to remotely monitor in real-time a status of one or more of the processing or control devices based on the data.

The present invention also provides, in a fourth aspect, a water quality management system comprising:

a server;

one or more personal devices communicatively connectable to the server;

a water purification subsystem;

a water monitoring subsystem; and

a communication subsystem connectable to the server;

the water monitoring subsystem collecting water quality and filter status data from the water purification subsystem, the server comparing the water quality and filter status data with set standards to monitor water quality and to determine if filter replacement is required.

Preferably, the personal devices are adapted to receive analysis from the server. Preferably, the personal devices are adapted to issue control commands to the filtration system.

In a fifth aspect, the present invention provides a method of managing a water management system, the water management system comprising:

a server;

one or more personal devices communicatively connectable to the server;

a water purification subsystem;

a water monitoring subsystem; and

a communication subsystem connectable to the server;

the water monitoring subsystem collecting water quality and filter status data from the water purification subsystem;

the method comprising:

comparing the water quality and filter status data with set standards to monitor water quality and to determine if filter replacement is required.

The present invention also provides, in a sixth aspect, a non-transitory computer-readable storage medium with an executable program stored thereon, wherein the program instructs a server to perform the method described above in the fifth aspect of the present invention.

Further features of various embodiments of the present invention are defined in the appended claims. It will be appreciated that features may be combined in various combinations in various embodiments of the present invention.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF DRAWINGS

Description of Drawings

Preferred embodiments in accordance with the best mode of the present invention will now be described, by way of example only, with reference to the accompanying figures, in which:

FIG. 1 is a schematic diagram of a water supply management system in accordance with an embodiment of the present invention;

FIG. 2 is a schematic diagram of a water supply management system in accordance with another embodiment of the present invention;

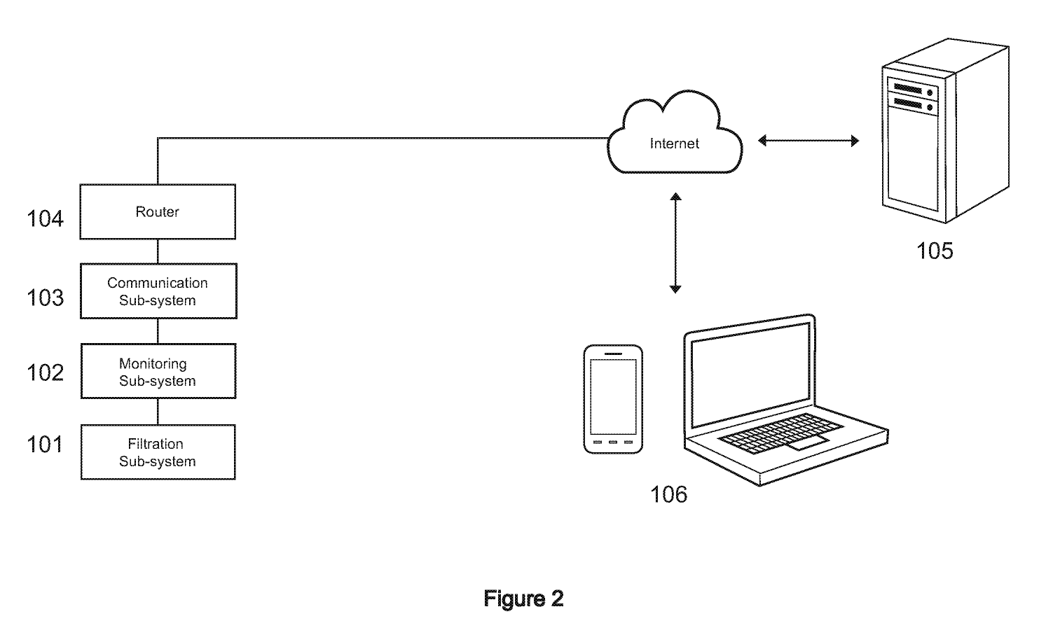

FIG. 3 is a schematic diagram of a portion of an identification device and a control module in accordance with an embodiment of the present invention;

FIG. 4 is a schematic diagram of a water supply management system in accordance with another embodiment of the present invention;

FIG. 5 is a schematic diagram of a water supply management system in accordance with yet another embodiment of the present invention;

FIG. 6 is a schematic diagram of a water supply management system in accordance with a further embodiment of the present invention;

FIG. 7 is a schematic diagram of a water supply management system in accordance with another embodiment of the present invention;

FIG. 8 is a schematic diagram of a portion of an identification device and a reader in accordance with an embodiment of the present invention; and

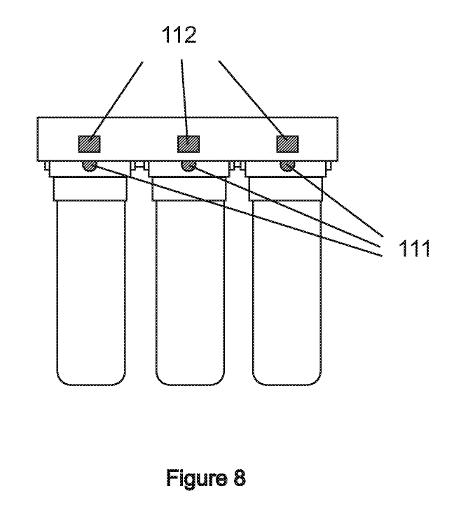

FIG. 9 is a schematic diagram of a reverse osmosis housing embedded with a TDS sensor in accordance with an embodiment of the present invention.

### MODE FOR THE INVENTION

Mode for Invention

Referring to the figures, a water supply management system for managing a water supply system having one or more water processing or control devices. The water processing or control devices can take the form of water processing devices such as polypropylene fibre filter 311, activated carbon filter 312, kinetic degradation fluxion (KDF) filter 313, activated carbon filter 361, polypropylene fibre filter 411, activated carbon filter 412, kinetic degradation fluxion (KDF) filter 413, activated carbon filter 431, ultrafiltration filter 402, other types of filters,and reverse osmosis membrane 304. The water processing or control devices can take the form of water control devices such as inlet solenoid valve 321, proportioning valve 381, flushing solenoid valve 382, other types of valves, pressure switch 305, other types of control switches, and storage tanks 307. The water processing or control devices can be referred to collectively as a filtration sub-system 101.

The water supply management system comprises one or more sensors 201, 202, 203, 204, 205, 206, with each sensor taking measurements of one or more parameters of a water supply passing through the water supply system. The sensors can be referred to collectively as a monitoring sub-system 102. One or more of the sensors measures one or more of the following parameters of the water supply: pressure, pH, alkalinity, total dissolved solids (TDS), turbidity, temperature, and flow rate.

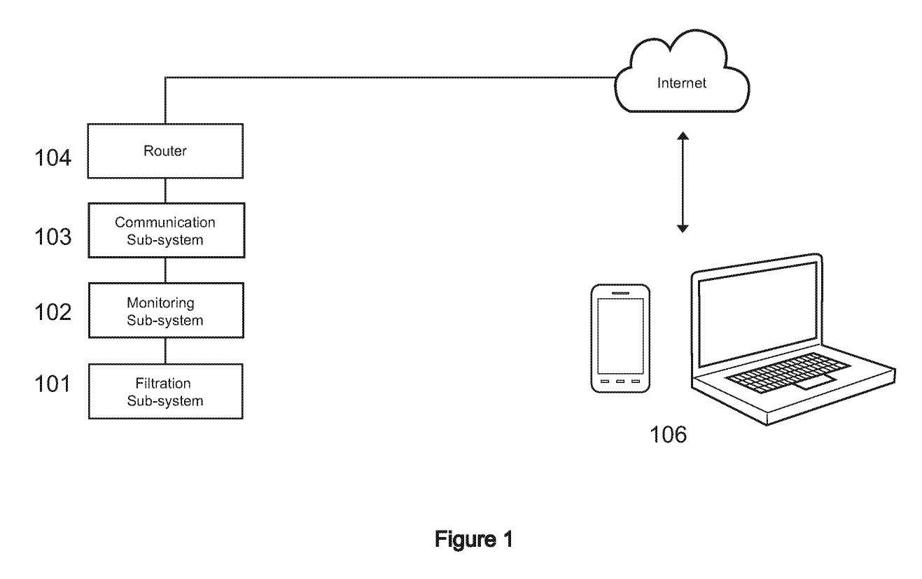

A communication module is connected to the sensors to receive the measurements in the form of data from the sensors. As shown in FIG. 1, the communication module takes the form of a communication sub-system 103 and a router 104. At least one computing device 105, 106 is remotely connected to the communication module to receive the data from the communication module, thereby to allow a user to use the computing device to remotely monitor in real-time a status of one or more of the processing or control devices based on the data.

At least one of the computing devices 105, 106 alerts the user when at least one of the measurements or at least one derived parameter derived from the data reaches a predetermined threshold. The same or another one of the computing devices can issue a control signal to control one or more of the water processing or control devices when at least one of the measurements or at least one derived parameter derived from the data reaches a predetermined threshold. The predetermined threshold can be preset by the user. The predetermined threshold can be preset for one or more of the water processing or control devices. For example, if the water processing or control device is a filter, the threshold could be a particular flow rate and/or a particular pressure difference across the filter that is indicative of the health of the filter. The predetermined threshold can alternatively or additionally be in accordance with industry standards.

In one embodiment, one of the sensors measures TDS of the water supply exiting the water supply system, thereby to allow the user to use the computing device to remotely record or to remotely monitor in real-time the TDS of the water supply exiting the water supply system. In another embodiment, one of the sensors measures TDS of the water supply entering the water supply system, thereby to allow the user to use the computing device to remotely record or to remotely monitor in real-time the TDS of the water supply entering the water supply system. In a further embodiment, one of the sensors measures TDS of the water supply exiting the water supply system, and another of the sensors measures TDS of the water supply entering the water supply system, thereby to allow the user to use the computing device to remotely record or to remotely monitor in real-time the difference in TDS of the water supply exiting and entering the water supply system.

In the present embodiment, one or more of the water processing or control devices is a water filter 361. One of the sensors 206 is a downstream pressure sensor that measures a downstream pressure downstream of the water filter 361. Another of the sensors 205 is an upstream pressure sensor that measures an upstream pressure upstream of the water filter, the difference between the downstream and upstream pressures defining a pressure drop across the water filter 361. Another of the water processing or control devices is a reverse osmosis membrane 304. One of the sensors 204 is a downstream pressure sensor that measures a downstream pressure downstream of the reverse osmosis membrane 304. Another of the sensors 203 is an upstream pressure sensor that measures an upstream pressure upstream of the reverse osmosis membrane, the difference between the downstream and upstream pressures defining a pressure drop across the reverse osmosis membrane 304.

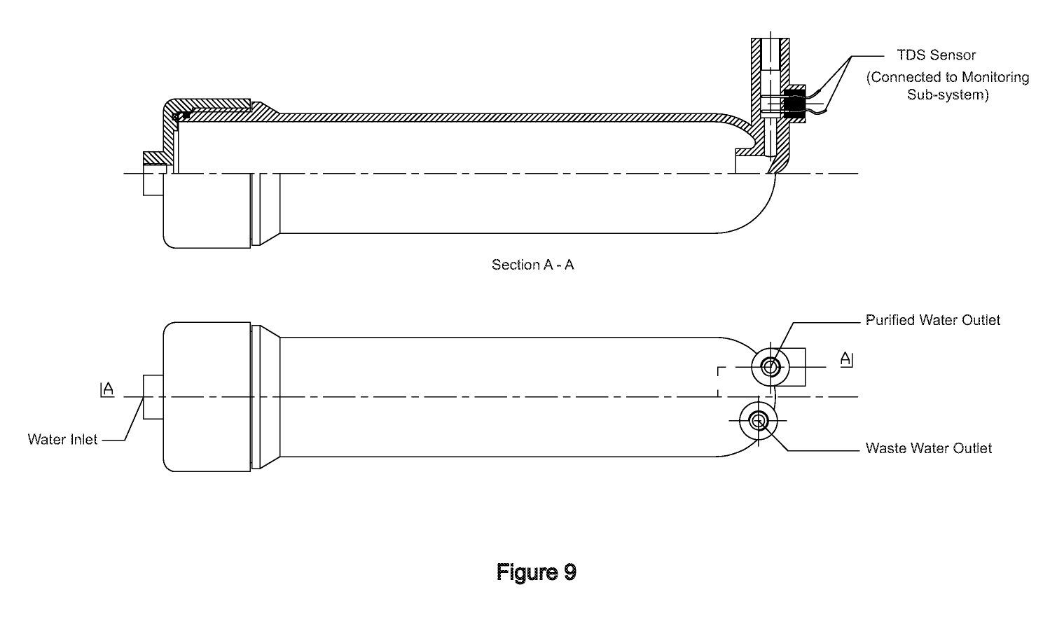

One or more of the water processing or control devices incorporates one or more of the sensors. For example, a TDS sensor can be integrated with a filter at the time of manufacture. One embodiment is shown in FIG. 9. In this embodiment, a TDS sensor is embedded in the housing of reverse osmosis membrane filter 304, and more particularly, the TDS sensor is located adjacent the purified water outlet of the reverse osmosis membrane filter 304.

One or more of the water processing or control devices includes an identification device 111 that provides identification information. The identification device can be one of the following: a label, a barcode, a near field communication (NFC) tag, and a radio frequency identification (RFID) tag.

The water supply management system comprises a reader 112 that detects the presence or absence of the water processing or control device in the water supply system, reads the identification information from the identification device 111, and provides the identification information in the form of data to the communication module. The identification information can comprise one or more of the following items of information corresponding to the water processing or control device: product identification, product serial number, model number, manufacture date, and calibration data.

In one embodiment, at least one of the computing devices 105, 106 has a data storage apparatus pre-stored with calibration data corresponding to one or more water processing or control devices. This particular computing device determines from the respective identification information the calibration data corresponding to the respective water processing or control device.

In the embodiment shown in the figures, the water supply management system has two or more of the computing devices. At least one of the computing devices is a server 105 and one or more of the other computing devices is a client device 106 communicating with the server 105. The client device 106 can be one of the following: a mobile device, a smartphone, a desktop computer, a laptop computer, and a personal device.

In an embodiment according to another aspect of the present invention, there is provided a water processing or control device for a water supply system, the water processing or control device comprising a sensor, the sensor being part of a water supply management system for managing a water supply system, the sensor taking measurements of one or more parameters of a water supply passing through the water supply system, the water supply management system comprising: a communication module connected to the sensor to receive the measurements in the form of data from the sensor; and at least one computing device remotely connected to the communication module to receive the data from the communication module, thereby to allow a user to use the computing device to remotely monitor in real-time a status of the processing or control device based on the data.

In an embodiment according to another aspect of the present invention, there is provided a water processing or control device for a water supply system, the water processing or control device comprising an identification device that provides identification information corresponding to the water processing or control device, the identification device for use in water supply management system comprising: one or more sensors, each sensor taking measurements of one or more parameters of a water supply passing through the water supply system;a communication module connected to the sensors to receive the measurements in the form of data from the sensors;a reader that detects the presence or absence of the water processing or control device in the water supply system, reads the identification information from the identification device, and provides the identification information in the form of data to the communication module; and at least one computing device remotely connected to the communication module to receive the data from the communication module, thereby to allow a user to use the computing device to remotely monitor in real-time a status of one or more of the processing or control devices based on the data.

A water quality management system in accordance with another embodiment of the present invention comprises a server 105, one or more personal devices 106 communicatively connectable to the server 105, a monitoring subsystem 102 and a communication subsystem 103 connectable to the server 105. The water monitoring subsystem 102 collects water quality and filter status data from the water purification subsystem 101. The communication system usually connects to the Internet via a router 104. The server compares the water quality and filter status data with the set standards to monitor water quality and to determine if filter replacement is required. The personal devices can receive analysis from the server and also issue control commands to the filtration system 101.

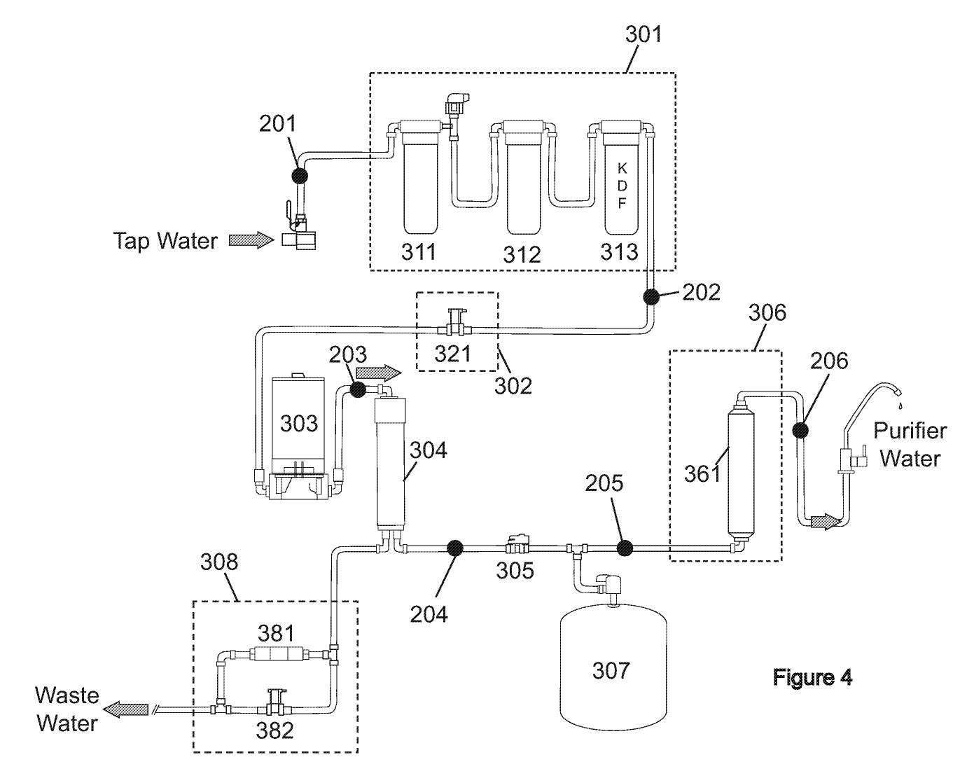

In another embodiment of the water quality management system, a reverse osmosis filtration system is shown in FIG. 4. Water from the cold water supply line enters the pre-filtration unit 301 first. There may be more than one pre-filter used in a reverse osmosis system. The most commonly used pre-filters are sediment filters, including-polypropylene fibre filter 311. These are used to remove sand silt, dirt and other sediment. Additionally, activated carbon filter 312 may be used to remove chlorine, which can have a negative effect on reversed osmosis membrane 304. A reverse osmosis membrane 304 has a pore size of approximately 0.0001 micron is effective in removing protozoa, bacteria, viruses and common chemical contaminants. After the water leaves the storage tank 307, the purified water goes through post-filtration 306. The post filter(s) is generally activated carbon filter 361. Any remaining tastes and odors are removed from the product water by post-filtration 306. When the storage tank 307 is full, the water inlet solenoid valve 321 stops any further water from entering the membrane, thereby stopping water production. By shutting off the flow this valve also stops water from flowing to the drain. Once water is drawn from the drinking water faucet, the pressure in the tank drops and the water inlet solenoid valve 321 opens, allowing water to flow to the reversed osmosis membrane 304 and waste-water (water containing contaminants) to flow down the membrane draining unit 308. When the pressure of the purified water reaches approximately 3 kg/cm², the pressure switch 305 will cut off the high pressure pump and stop water production. When purified water is being used and the pressure is reduced to approximately 1.5 kg/cm², water production will resume. Water flow through the reversed osmosis membrane 304 is regulated by the proportioning valve 381. A bladder inside the storage tank 307 keeps water pressurized in the tank when it is full. The flushing solenoid valve 382 is connected to the waste outlet of the reversed osmosis membrane in parallel to the proportional valve 381. The flushing control module is electrically connected to the flushing solenoid valve 382 and controls the operation of the water flushing solenoid valve 382.

If water going through a filter experiences a pressure drop, the difference in the static-pressure readings before and after the filter provide a good indication of the condition of the filter. Different filter configurations and micron ratings have different replacement specifications. Whether pressure loss can be used as an indication of filter condition will depend on the measurability of the pressure drop for that particular filter type. Measurability will also depend on the accuracy of the pressure sensor.

According the energy equation for a fluid the total energy can be summarized as elevation energy, velocity energy and pressure energy. The energy equation can then be expressed as:

p₁+ρv₁²/2+ρg h₁=p₂+ρv₂²/2+ρg h₂+pₗₒₛₛ (1)

where

p=pressure in fluid (Pa (N/m²), psi (lb/in²))

pₗₒₛₛ=pressure loss (Pa (N/m²), psi (lb/in²))

ρ=density of the fluid (kg/m³, slugs/ft²)

v=flow velocity (m/s, ft/s)

g=acceleration of gravity (m/s², ft/s²)

h=elevation (m, ft)

For steady state flow v₁=v₂ and when the change in elevation is negligible h₁=h₂, (1) can be transformed to:

pₗₒₛₛ=p₁−p₂ (2)

The pressure loss can be further divided into:

1. pressure loss due to the filter element itself which increases with the deterioration of the filter element.

2. pressure loss due to friction and change of velocity in bends of the actual product and can be expressed as a dependent variable of flow velocity.

When the pressure loss at a particular flow rate reaches a preset threshold value, the system can prompt the user to replace the filter. In some embodiments, the precise emphirical relationship between pressure loss and these factors is obtained through experimental work with the actual product.

In the present embodiment of the water quality management system, the sensor unit #1 201, is installed between the water supply inlet and the pre-filtration unit, the sensor unit measures tap water parameters including total dissolved solids (TDS), flow volume and inlet pressure. The sensor unit #2 202 is installed between the outlet of pre-filtration unit 301 and the pressure drop across the filters provides a cumulative indication of the condition of the filters in the pre-filtration unit 301. Similarly, the pressure difference between sensor unit #3 203 and sensor #4 204, and between unit #5 205 and sensor #6 206 provide indications of the conditions of the reverse osmosis membrane 304 and the post-filtration unit 306 respectively. The sensor unit #6 206 additionally measures water parameters including TDS and provide information about water quality and the effectiveness of the filtration subsystem when compared with the corresponding inlet water quality data.

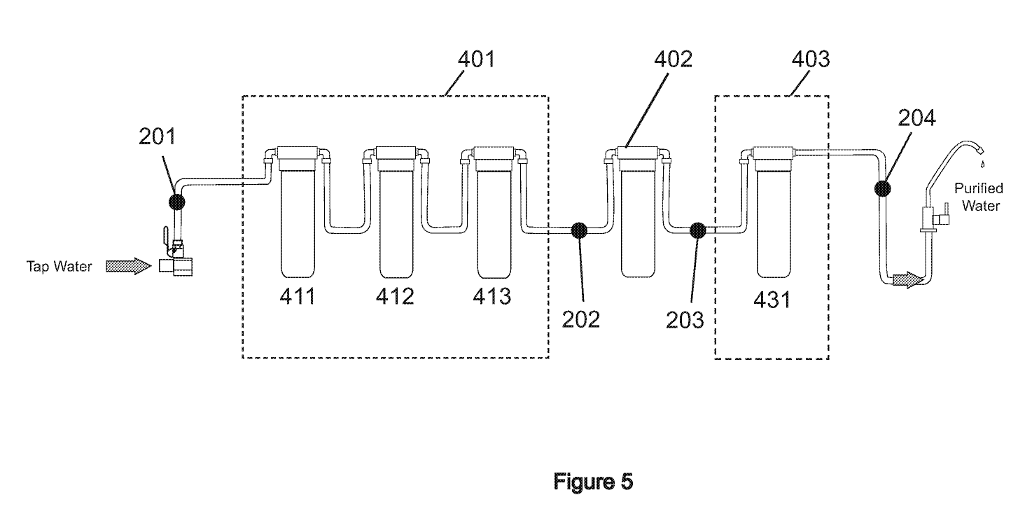

In another embodiment of the water quality management system, an ultrafiltration system is shown in FIG. 5. Water from the cold water supply line enters the pre-filtration unit 401 of the ultrafiltration system first. There may be more than one pre-filter used in an ultrafiltration system. The most commonly used pre-filters are sediment filters, including polypropylene fibre filter 411. These are used to remove sand silt, dirt and other sediment. Sometimes, a kinetic degradation fluxion (KDF) filter 413 is used to remove chlorine, lead, mercury, iron, and hydrogen sulfide from water supplies. The process also has a mild anti-bacterial, algaecitic, and fungicitic, effect and may reduce the accumulation of lime scale. An ultrafiltration filter 402 has a pore size of approximately 0.01 micron (pore size ranges vary by filter from 0.001 micron to 0.05 micron). Ultrafiltration has a very high effectiveness in removing protozoa, bacteria, viruses but has a low effectiveness in removing chemicals. The post-filter(s) is generally carbon and any remaining tastes and odors are removed from the product water by post filtration. Sensors are strategically placed to measure pressure drop and as explained earlier, their effectiveness will depends on filter type and the accuracy of the pressure sensors.

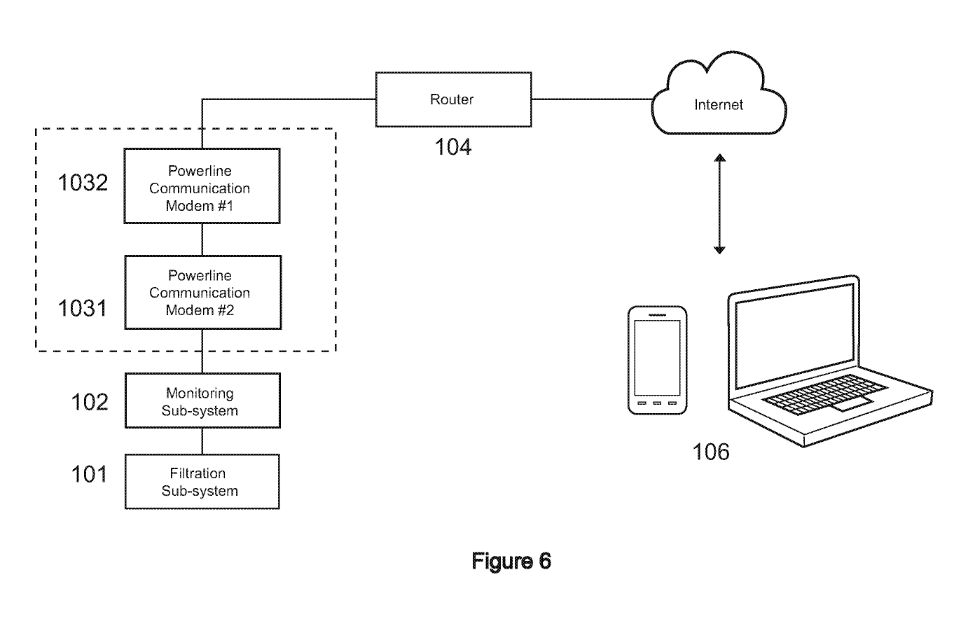

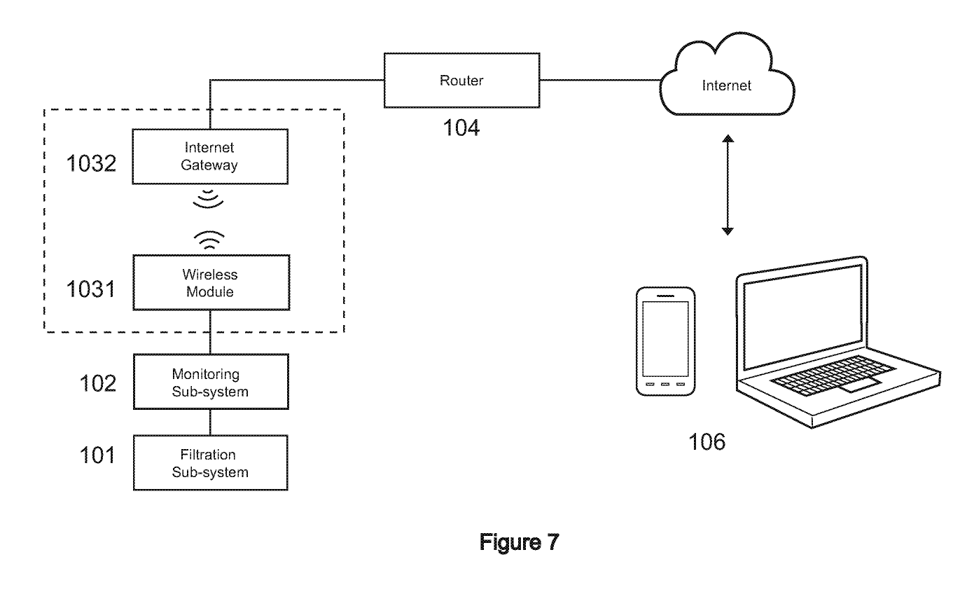

In a further embodiment of the water quality management system, the system comprises a router 104 and connected to the server 105 via the Internet. Data collected by the monitoring sub-system 102 is forwarded to the communication sub-system 103 which is connected with the router 104. As best shown in FIG. 6, the communication sub-system 103 can include powerline communication modem #1 1032 and powerline communication modem #2 1031. In another embodiment, as best shown in FIG. 7, the communication sub-system 103 can include wireless module 1031 and Internet gateway 1032. Data analysis is carried out in the server 105 including comparing the water quality and filter status data with the set standards to monitor water quality and to determine if filter replacement is required. The personal devices 106 can receive analysis from the server and also issue control commands to the filtration system 101. The server can communicate with the personal devices through SMS, email, and push notification and also enable the users to monitor water quality in real time with an application program.

Additionally, the use of GPS-enabled location data on smartphones or user's location input will enable the location of the water quality management system to be known by the server 105. The will allow the server to analyses water quality of the supply source for a certain defined area, provided that the user permits the use of these data to perform said statistically analysis. The statistics will provide a full picture of the water quality for that particular area.

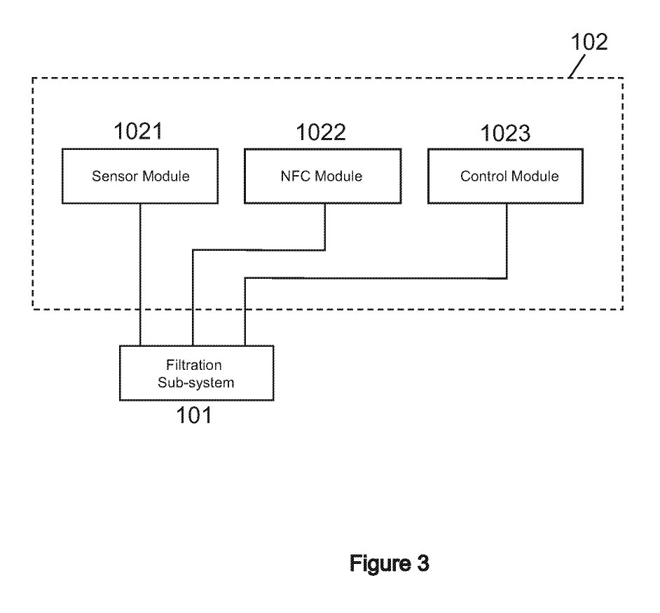

Preferably, as shown in FIG. 3, the monitoring subsystem 102 comprises: monitoring each sensor module of the filter 1021 is connected to the subsystem 101, the filter identification module 1022, a control module 1023.

In a further embodiment of the water quality management system, filter identification module 1022 is used to identify each filter, the information includes the product ID and serial number of each filter. The method includes the use of Near Field Communication (NFC) tag and reader. The system read the tag information regularly to ascertain if the filter has been replaced. The sensor unit can be embedded into the filter housing and with its calibration constant(s) written into the tag. The monitoring subsystem 102 can use these data and ensure that the correct constant(s) corresponded to that sensor unit has been updated. Alternatively, these calibration constants can be stored in the server 105 and made accessible to the monitoring subsystem 102 via the Internet.

With embodiments of the present invention, a user will be able to receive real-time updates of water quality data and detailed analysis of a variety of parameters of the water supply passing through the water supply system, resulting in improved water quality monitoring as well as optimized recommendations for filter replacement schedules.

It can be appreciated that the aforesaid embodiments are only exemplary embodiments adopted to describe the principles of the present invention, and the present invention is not merely limited thereto. Various variants and modifications may be made by those of ordinary skill in the art without departing from the spirit and essence of the present invention, and these variants and modifications are also covered within the scope of the present invention. Accordingly, although the invention has been described with reference to specific examples, it can be appreciated by those skilled in the art that the invention can be embodied in many other forms. It can also be appreciated by those skilled in the art that the features of the various examples described can be combined in other combinations. In particular, there are many possible permutations of the circuit arrangements described above which use the same passive method to achieve passive power factor correction, and which will be obvious to those skilled in the art.

1. A water supply management system for managing a water supply system having one or more water processing or control devices, the water supply management system comprising:
one or more sensors, each sensor taking measurements of one or more parameters of a water supply passing through the water supply system;
a communication module connected to the sensors to receive the measurements in the form of data from the sensors; and
at least one computing device remotely connected to the communication module to receive the data from the communication module, thereby to allow a user to use the computing device to remotely monitor in real-time a status of one or more of the processing or control devices based on the data.

2. A water supply management system according to claim 1 wherein one or more of the sensors measures one or more of the following parameters of the water supply:
pressure, pH, alkalinity, total dissolved solids (TDS), turbidity, temperature, and flow rate.

3. A water supply management system according to claim 1 wherein at least one of the computing devices alerts the user when at least one of the measurements or at least one derived parameter derived from the data reaches a predetermined threshold.

4. A water supply management system according to claim 1 wherein at least one of the computing devices issues a control signal to control one or more of the water processing or control devices when at least one of the measurements or at least one derived parameter derived from the data reaches a predetermined threshold.

5. A water supply management system according to claim 3 wherein the predetermined threshold is preset by the user.

6. A water supply management system according to claim 3 wherein the predetermined threshold is preset for one or more of the water processing or control devices.

7. (canceled)

8. A water supply management system according to claim 1 wherein one of the sensors measures TDS of the water supply exiting the water supply system, thereby to allow the user to use the computing device to remotely record or to remotely monitor in real-time the TDS of the water supply exiting the water supply system.

9. A water supply management system according to claim 1 wherein one of the sensors measures TDS of the water supply entering the water supply system, thereby to allow the user to use the computing device to remotely record or to remotely monitor in real-time the TDS of the water supply entering the water supply system.

10. A water supply management system according to claim 1 wherein one of the sensors measures TDS of the water supply exiting the water supply system, and another of the sensors measures TDS of the water supply entering the water supply system, thereby to allow the user to use the computing device to remotely record or to remotely monitor in real-time the difference in TDS of the water supply exiting and entering the water supply system.

11. A water supply management system according to claim 1 wherein one or more of the water processing or control devices is a water filter.

12. A water supply management system according to claim 11 wherein one of the sensors is a downstream pressure sensor that measures a downstream pressure downstream of the water filter.

13. A water supply management system according to claim 12 wherein another of the sensors is an upstream pressure sensor that measures an upstream pressure upstream of the water filter, the difference between the downstream and upstream pressures defining a pressure drop across the water filter.

14. A water supply management system according to claim 1 wherein one or more of the water processing or control devices incorporates one or more of the sensors.

15. A water supply management system according to claim 1 wherein one or more of the water processing or control devices includes an identification device that provides identification information.

16. (canceled)

17. A water supply management system according to claim 15 comprising a reader that detects the presence or absence of the water processing or control device in the water supply system, reads the identification information from the identification device, and provides the identification information in the form of data to the communication module.

18. A water supply management system according to claim 15 wherein the identification information comprises one or more of the following items of information corresponding to the water processing or control device: product identification, product serial number, model number, manufacture date, and calibration data.

19. A water supply management system according to claim 15 wherein at least one of the computing devices has a data storage apparatus prestored with calibration data corresponding to one or more water processing or control devices, said computing device determining from the respective identification information the calibration data corresponding to the respective water processing or control device.

20. A water supply management system according to claim 1 having two or more of the computing devices, wherein at least one of the computing devices is a server and one or more of the other computing devices is a client device communicating with the server.

21. (canceled)

22. A water processing or control device for a water supply system, the water processing or control device comprising a sensor, the sensor being part of a water supply management system for managing a water supply system, the sensor taking measurements of one or more parameters of a water supply passing through the water supply system, the water supply management system comprising:
a communication module connected to the sensor to receive the measurements in the form of data from the sensor; and
at least one computing device remotely connected to the communication module to receive the data from the communication module, thereby to allow a user to use the computing device to remotely monitor in real-time a status of the processing or control device based on the data.

23. A water processing or control device for a water supply system, the water processing or control device comprising an identification device that provides identification information corresponding to the water processing or control device, the identification device for use in water supply management system comprising:
one or more sensors, each sensor taking measurements of one or more parameters of a water supply passing through the water supply system;
a communication module connected to the sensors to receive the measurements in the form of data from the sensors;
a reader that detects the presence or absence of the water processing or control device in the water supply system, reads the identification information from the identification device, and provides the identification information in the form of data to the communication module; and
at least one computing device remotely connected to the communication module to receive the data from the communication module, thereby to allow a user to use the computing device to remotely monitor in real-time a status of one or more of the processing or control devices based on the data.
